(19) United States
(12) Patent Application Publication
(10) Pub. No.: US 2009/0151186 A1
(43) Pub. Date: Jun. 18, 2009

(54) Easy clean dryer vent hookup

(76) Inventor: Thomasene Filmore, Saint Louis, MO (US)

Correspondence Address: Thomasene Filmore, 4454 Delor Street, Saint Louis, MO, 63116, US

(21) Appl. No.: 12/002,511

(22) Filed: Dec. 17, 2007

(51) Int. Cl. F26B 21/00; F26B 25/06

(52) U.S. Cl. 34/82; 34/235

(57) ABSTRACT

A Clean Dryer Vent Hookup is designed to make the removal and reconnection of the dryer hose an easy process for periodic lint removal. The removable base, having a center hole the diameter to accommodate a standard dryer hose, is attached to the rear of the dryer vent. Four adhesive flaps that are attached to the base are extended to allow placement of the hose through the base and into the dryer well. Protective covering is removed from the adhesive on the flaps so they adhere to the hose to hold it secure. Lint can be removed and a new Vent Hookup unit installed.

### CROSS REFERENCE

Not applicable

### FEDERALLY SPONSORED

Not applicable

### SEQUENCE LISTING

Not applicable

### BACKGROUND OF INVENTION

For safety and preventative maintenance, we periodically disengage the inside hose from the dryer to clean out excess trapped lint. We had purchased a larger capacity dryer, and also purchased the newer non-flexible hose that is more fire resistant. After more than an hour of unsuccessfully trying to re-fit the old ‘screw and rod’ to the new hose, and yet more time hooking the hose up to the dryer with duct tape the job was finished. I could not get out of my mind the inordinate amount of time and aggravation it took to accomplish this task and set my mind to thinking of a better way, otherwise the hose would probably not be cleaned until the duct tape disintegrated.

### BRIEF SUMMARY

The object of my product is to have an inexpensive, quick and efficient way to facilitate routine cleaning of the inside dryer hose of lint. My product would fit snugly on the hose and be secured to the back of the dryer by four sections having heat resistant adhesive fit on them. The product also would be cost effective to allow for safely removing the hookup unit to allow for disposing of built up lint on a periodic basis.

### DRAWINGS

(if any): None provided at this time.

### DETAILED DESCRIPTION OF THE INVENTION

The base would be approximately 6″×6″ heat resistant square backing (hard cardboard or plastic) having an approximately 14″ diameter hole to snugly fit on to the dryer hose. The base will have four quarter sections mounted to it, each section having a removable adhesive backing covered by protective sheet. When the sections are opened the hole is exposed and can be fitted on to the dryer hose. The dryer hose is positioned back into the dryer well, the base unit is positioned to the back of the dryer and the protective sheets can be removed. The hose is now secured.

### Applicant Claims Small Entity Status

This is an independent invention based on frustration and the desire to make this a much easier aid to application and cleaning.

### Abstract of the Disclosure

Not applicable.

### Sequence of Listing

Not applicable.

1. A removable self-adhesive dryer vent hookup comprising of:
The approximate size of the dryer hookup base is 6″×6″ square by ⅛″ in height.
The base will be heat resistant hard cardboard or plastic.
The square base will have a hole that is approximately 14″ in diameter in the middle.
The 14″ diameter hole is the size of a standard dryer vent hose.
The base will have four quarter sections mounted onto it.
Each quarter section will have removable adhesive backing.
The adhesive backing will allow the unit to adhere to the back of the clothes dryer.
When the quarter sections are open to expose the center hole the base can be fit on to the dryer hose.
The base will fit snugly on the dryer hose preventing excess heat loss.
Once the base is in place on the dryer hose the hose is then fit back into the dryer well.
With the opened sections the entire hookup unit is then positioned flush to be back of the dryer.
The protective paper on the quarter sections are then removed and pressed against the back of the dryer to secure adhesive.
The hose is now secured.
When it is time to clean the dryer hose of lint again just peel off the old unit and replace it with a new unit.
